(19) United States
(12) Patent Application Publication
(10) Pub. No.: US 2019/0383933 A1
(43) Pub. Date: Dec. 19, 2019

(54) SUBSURFACE LOCATION APPARATUS

(71) Applicant: Dellafindit, LLC, Kingwood, TX (US)

(72) Inventor: Delbert Oehme, Kingwood, TX (US)

(73) Assignee: Dellafindit, LLC, Kingwood, TX (US)

(21) Appl. No.: 16/011,358

(22) Filed: Jun. 18, 2018

(51) Int. Cl. G01S 13/88

(52) U.S. Cl. CPC G01S 13/885

(57) ABSTRACT

An apparatus for detecting an object, including a transmitter and an antenna that receives a signal from the transmitter, radiates a transmitted beam of electromagnetic energy, and receives a reflected beam of electromagnetic energy, the reflected beam being a reflection of the transmitted beam when the transmitted beam is reflected from an object. The apparatus further includes a phase detector in communication with the antenna that detects a phase difference between the transmitted beam and the reflected beam, and that produces an output based on the phase difference, and a voltage meter that receives the output and produces a voltage reading.

### TECHNICAL FIELD

The present invention relates to an apparatus and method for locating objects. In particular, the invention can facilitate the detection of objects buried in the ground or otherwise embedded in a given separate material, such as underground metal and plastic pipes, roots, and cables buried in the earth, including under concrete, water, or asphalt. Such detection may be useful in utilities, mining, oil & gas, military, medical, or emergency services fields.

### BACKGROUND OF THE INVENTION

Objects embedded in a separate material are often difficult to detect and hidden from view. Because the separate material may be opaque, an observer must use more than visual means to determine whether an object is present. For example, the accidental severing of an underground pipe or electrical cable during excavation could have catastrophic consequences for the excavator as well as utility service customers. The detection of such objects can also be important in the discovery and production of minerals and petrochemicals. Further, the detection of objects within the human body (e.g., kidney stones, gall stones, and tumors) can help with diagnosis and treatment of various medical conditions.

Based on these risks of damaging objects embedded in a second material and a desire to avoid physical removal of the second material to detect the object, techniques have been developed to non-destructively detect hidden objects. One method of such detection is to induce or transmit an electrical current to or through the hidden object and determine the object's location based on an electromagnetic field generated by the flow of the current within or through the object. This technique may be used to identify the locations of pipes, wires, and other conductive materials, such as metal objects buried on ocean shore. However, this inductive detection method cannot be used to detect nonconductive materials, such as plastics or ceramics, which do not readily conduct electrical currents. Additionally, this inductive approach is limited in its application.

To detect objects made of such nonconductive materials, ground penetrating radar (GPR) has been used. GPR generally operates by transmitting electromagnetic pulses in the microwave band (10 MHz to 2.6 GHz) from an antenna and determining the presence of underground objects based on the reflections of the pulses and the conductivities and dielectric constants of the objects, received by a receiving antenna. The data generated from the reflections are typically plotted on as a pattern on a radargram display and may be later processed for more detailed analysis. GPR devices are typically relatively large and complex and can be costly to rent or purchase. GPR is also limited by trade-off between penetration depth and data resolution—high frequency electromagnetic pulses provide superior resolution but have limited penetration. And in heavy clay soils, GPR effectiveness is severely compromised.

Consequently, there is a need for a system and method for locating objects that is simple, inexpensive, and able to reflect from a variety of materials with adequate resolution and depth. Such a system and method would be desirable for use for a variety of applications in a variety of industries.

### SUMMARY OF THE INVENTION

One aspect of the present technology provides an apparatus for detecting an object, including a transmitter and an antenna that receives a signal from the transmitter, radiates a transmitted beam of electromagnetic energy, and receives a reflected beam of electromagnetic energy, the reflected beam being a reflection of the transmitted beam when the transmitted beam is reflected from an object. The apparatus further includes a phase detector in communication with the antenna that detects a phase difference between the transmitted beam and the reflected beam, and that produces an output based on the phase difference, as well as a voltage meter that receives the output and produces a voltage reading.

In certain embodiments, the antenna can be a log periodic antenna, and the apparatus can further include a laser aligned approximately in the direction between the antenna and the object. In addition, the apparatus can further include a levelling device attached or integral to the apparatus to detect the orientation of the apparatus, and an oscilloscope in communication with the voltage meter that displays an output based on the voltage reading. Furthermore, the apparatus may further include a potentiometer in communication with the phase detector and the voltage meter to adjust the output, and a frequency modulator in communication with the antenna.

In some example embodiments, the apparatus can include a handle to enable hand-held operation by a user, and the frequency of the transmitted beam can be about 2.4 GHz. In addition, the reflected beam can have a different phase from the transmitted beam, the phase difference based on the distance between the apparatus and the object. Furthermore, the apparatus can include an output component that receives the voltage reading from the voltage meter, and a display that produces a second output based on the voltage reading. The apparatus can also include a location detection component.

Another aspect of the present technology provides a method of detecting an object. The method includes the steps of a) transmitting a transmitted beam of electromagnetic energy at an object, b) receiving a reflected beam of electromagnetic energy, the reflected beam being a reflection of the transmitted beam when the transmitted beam is reflected from the object, the reflected beam having a different phase from the transmitted beam based on the distance between the apparatus and the object, and c) producing an output based on the phase difference. The method further includes the steps of d) receiving with the voltage meter the output based on the phase difference, and e) producing with the voltage meter a corresponding voltage reading.

In certain embodiments, the method can further include the step of displaying on a display an output based on the voltage reading. In addition, steps a) and b) of the method can include transmitting and receiving the respective beams of electromagnetic energy with an antenna.

In some embodiments, the method can further include the steps of performing steps a) and b) a first time with the transmitted beam of electromagnetic energy directed substantially vertically downward toward the object, recording a first location based on the location of the source of the transmitted beam during performance of this step, performing steps a) and b) a second time with the transmitted beam of electromagnetic energy directed at an angle toward the object, and recording a second location based on the location of the source of the transmitted beam during performance of this step. Furthermore, the method can include the step of determining the depth of the object based on the first location, the second location, and the angle of the transmitted beam at the second location. In other embodiments, certain steps can be performed while the first apparatus is attached to a vehicle, and while the second apparatus is attached to the vehicle.

Yet another aspect of the present technology provides a vehicle for detecting a buried object, including a first apparatus for detecting the buried object and a second apparatus for detecting the buried object. The first apparatus includes a first transmitter, a first antenna that receives a signal from the first transmitter, radiates a first transmitted beam of electromagnetic energy substantially vertically toward the buried object, and receives a first reflected beam of electromagnetic energy, the first reflected beam being a reflection of the first transmitted beam when the first transmitted beam is reflected from an object, and a first phase detector in communication with the first antenna that detects a phase difference between the first transmitted beam and the first reflected beam, and that produces a first output based on the phase difference.

The second apparatus includes a second transmitter, a second antenna that receives a signal from the second transmitter, radiates a second transmitted beam of electromagnetic energy at an angle toward the buried object, and receives a second reflected beam of electromagnetic energy, the second reflected beam being a reflection of the second transmitted beam when the second transmitted beam is reflected from an object, and a second phase detector in communication with the second antenna that detects a phase difference between the second transmitted beam and the second reflected beam, and that produces a second output based on the phase difference. The vehicle further includes a first marker identify the position of the first apparatus when the object is identified, and a second marker to identify the position of the second apparatus when the object is identified.

In some embodiments, the vehicle can include a first voltage meter that receives the first output and produces a first voltage reading, and a second voltage meter that receives the second output and produces a second voltage reading.

### BRIEF DESCRIPTION OF THE DRAWINGS

The present technology will be better understood upon reading the following detailed description of non-limiting embodiments thereof, and upon examining the accompanying drawings described below:

FIG. 1 is a rear perspective view of an exemplary locator apparatus according to an embodiment of the technology.

FIG. 2 is a side perspective view of the exemplary locator apparatus.

FIG. 3 is a top view of the exemplary locator apparatus.

FIG. 4 is a diagram showing possible utilization of an exemplary locator apparatus to detect the depth to an object.

FIG. 5 is a diagram showing possible utilization of multiple exemplary locator apparatuses to detect an object.

FIG. 6 is an electric diagram of an exemplary locator apparatus according to an embodiment of the present technology.

FIG. 7 is a side view of a cart apparatus upon which multiple exemplary locator apparatuses are mounted.

FIG. 8 is a front view of a cart apparatus upon which multiple exemplary locator apparatuses are mounted.

### DETAILED DESCRIPTION

The present invention provides apparatuses and methods to detect objects hidden from view that are simple, inexpensive, able to detect a wide variety of objects embedded in other materials, and generally unaffected by interference.

The apparatus comprises an antenna capable of transmitting and receiving electromagnetic energy. The antenna possess a radiation pattern generally pointing in a given direction, and may be a log-periodic, Yagi, parabolic, sector, patch, microstrip, or other type of directional or semi-directional antenna. Such a directional or semi-directional antenna enables the apparatus to radiate a transmitted beam of electromagnetic energy in generally a single direction, and to receive a reflection beam from the same direction. The reflected beam, a reflection of the transmitted beam reflected from an object, having a phase difference from the transmitted beam, based on the distance between the object and the antenna. When the transmitted beam is reflected from a stationary object, the reflected beam maintains the same frequency as the transmitted beam—enabling the apparatus to identify that the beam is the reflection of the transmitted beam and avoid interference from other signals.

The apparatus further includes a transmitter capable of producing, when in conjunction with an antenna, a continuous beam of electromagnetic energy having a constant frequency in the microwave range (10 MHz to 2.6 GHz). Lower frequencies require larger antennas. In some embodiments, the frequency can be around 2.4 GHz, but any frequency in this range could be used. The apparatus may additionally include a modulator to modulate the frequency supplied to the antenna, enabling the apparatus to produce a transmitted beam having a higher or lower frequency. The transmitter may be configured to transmit a video or data signal, enabling the antenna of the apparatus to transmit video or data. The transmitter may also be a transceiver, functioning as a receiver as well as a transmitter, receiving the reflected beam, and sending it to a phase detector. A phase detector is a device that generates a voltage signal representing the difference in phase between two inputs. In one example embodiment, the phase detector detects the phase difference between the transmitted beam and the reflected beam and outputs a voltage corresponding to this difference. However, any receiver should not interfere with the phase of the reflected beam that is received by the phase detector, because the phase detector must receive the phase of the reflected beam accurately for the voltage output by the phase detector to accurately correspond to the phase difference between the transmitted beam and the reflected beam.

Additionally, the apparatus includes a voltage meter and a display, which displays an output based on the voltage output from the phase detector. Thus, the display output is based on the phase difference between the transmitted beam and the reflected beam. A potentiometer may also be in communication with the voltage meter to allow a user to offset local fields in the presence of a close, large, reflection. An oscilloscope may also communicate with the phase detector to visually depict the voltage difference between the transmitted beam and the received reflected beam.

Because materials differ in their reflectivity of electromagnetic energy, the apparatus is able to differentiate between various materials, such as metals, polymers, ceramics, bones, and even between living and dead roots. The differences in reflectivity also implicate effective ranges, where the apparatus may track, for example, PVC pipes at 50 feet away and metal lines at 100 feet away. As additional examples of the capabilities of the apparatus, it is capable of detecting a kernel of popcorn on the ground from a range of 10 feet, or a penny on concrete from a range of 30 feet.

An apparatus for detecting objects according to the present technology may be utilized in a wide variety of industries for a wide variety of applications. For example, it may be useful for finding pipes, wires, rocks, and other buried objects in the ground, through water, through snow and ice, or through another material. The outline of the detected object may be marked and traced on the surface of the material. For example, the shape of an object buried underground may be traced on the ground to potentially aid in the identification of the object. In addition, it may be useful for finding buried or hidden pipelines, conduits, or other equipment in the electrical and water utilities, mining, and/or oil & gas industries. Moreover, every day consumers may use the device for investigating their property to identify buried utilities, sprinkler lines, tree roots, rocks, or other objects. Tree roots may be particularly helpful to detect prior to pouring concrete or laying paths, to eliminate the future risk of damaging the concrete by roots growing underneath. In the military, the apparatus may be utilized to identify land mines or other foreign objects hidden from view. And for emergency services, the apparatus could assist in finding people or objects in collapsed buildings, floods, or avalanches. In household applications, the apparatus may be used to find studs in walls, chase plumbing and pipes and find clogs or monitor the flow of a fluid therein, and potentially to investigate building foundations.

An apparatus for detecting objects may further be utilized for 3D scanning, where the apparatus scans from left to right with a fixed vertical position, scans left to right at a second vertical position, and repeats until a region has been completely scanned. By combining the data from scanning in different perspectives, the precise shape of a hidden object may be ascertained. Optionally, the three-dimensional scan of the apparatus may be depicted two dimensionally with various colors indicating different depths, potentially based on voltage measured by a phase detector of the locator apparatus.

In the medical field in particular, the exemplary range of electromagnetic energy utilized by this apparatus may be utilized to identify objects within the body. For example, kidney stones and other mineral stones may be located, as well as bone structure analyzed without the need for ultrasound or x-rays. Ultrasound is not always able to effectively locate objects. And x-rays are ionizing radiation, which increases cancer risk. The apparatus may also be applied to locate blood veins and blockages, among other objects in the body. As a result, it could also be utilized to fight smuggling of various objects without requiring invasive searching.

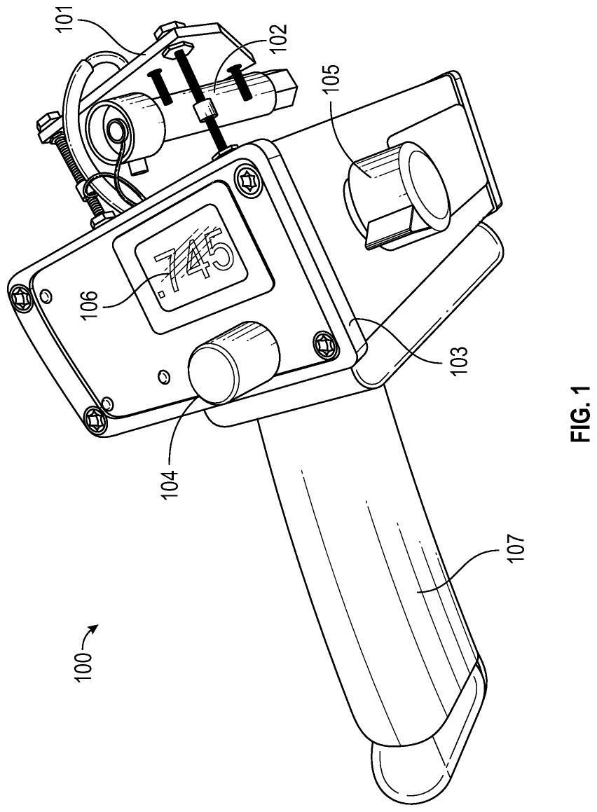

Referring now to the figures, FIG. 1 is a rear perspective view of an exemplary apparatus for locating objects hidden from view 100 according to one example embodiment of the present technology. The antenna 101 is positioned on the top of the apparatus 100 and electrically coupled to the apparatus body 103 by radio frequency (RF) cable. A laser pointer 102 is mounted in line with the direction of the antenna 101 and also coupled to the apparatus body 103. The laser pointer may alternatively be mounted directly on the apparatus body 103, within the apparatus body 103, or omitted. The laser pointer may be activated by a button on the handle 107, continuously active while the apparatus is powered on, or activated in another manner A power switch 104 is present on the rear face of the apparatus 100, along with a digital LCD display 106, which presents a numerical representation of the phase shift between the transmitted beam transmitted by the antenna 101 and a reflected beam received by the same antenna 101. The numerical representation is based on the voltage received by a volt meter, the voltage based on the phase difference between the transmitted beam and the reflected beam. A potentiometer knob 105 is present on the side of the apparatus to adjust the range of the voltage supplied to the volt meter. The handle of the depicted apparatus 107 allows a user to conveniently use the apparatus in a hand-held manner Larger or smaller apparatuses, with or without handles, are contemplated, depending on the particular application in which the apparatus is to be used.

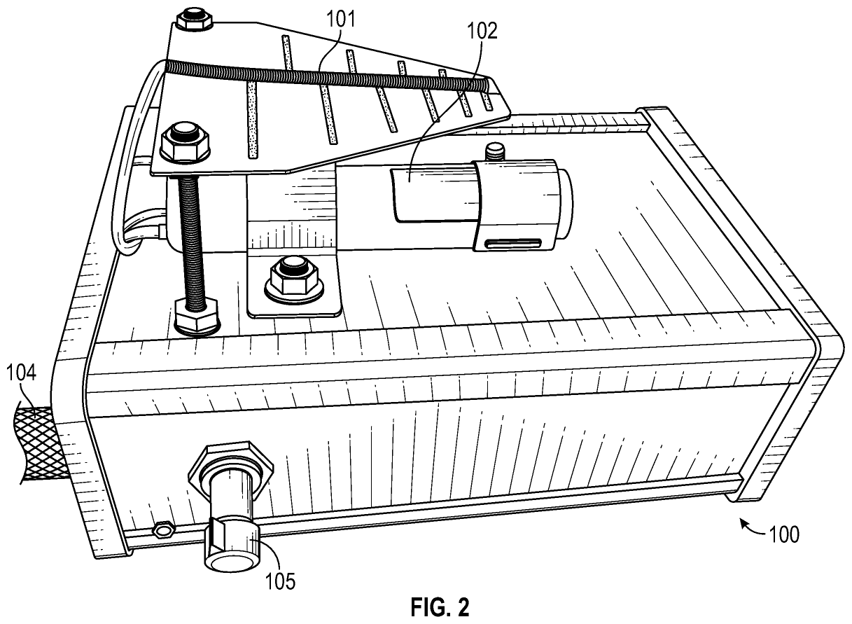

FIG. 2 is a side perspective view of an exemplary apparatus for locating objects hidden from view 100. The antenna 101 and laser pointer 102 are attached to the body of the apparatus 103. The antenna 101 depicted in FIG. 2 is a log-periodic antenna, but any other antenna with a directional radiation pattern may be used. The antenna 101 may additionally be positioned in any orientation along the apparatus body 103, such as near the digital LCD display 106 at the rear of the apparatus body 103 or closer to the front of the body 103, further from the digital LCD display 106. A power knob 104 and potentiometer knob 105 are accessible on the rear and side of the apparatus body 103, respectively.

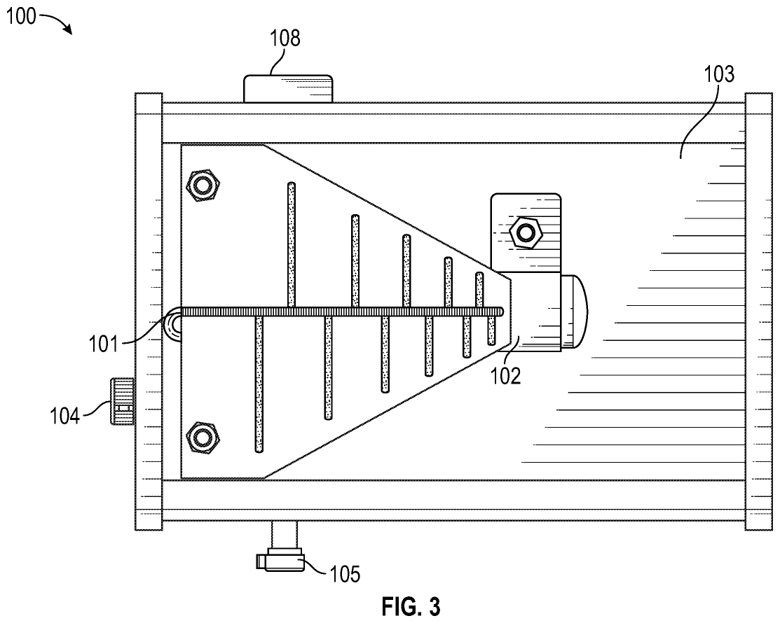

FIG. 3 is a top view of an exemplary apparatus for locating objects hidden from view 100. The antenna 101 and laser pointer 102 are attached to the body of the apparatus 103. A power knob 104 and potentiometer knob 105 are accessible on the rear and side of the apparatus body 103, respectively.

A levelling device 108 can also be attached to the left side of the apparatus body 103, optionally positioned at a 45 degree angle from the direction of the antenna 101. The levelling device 108 can help to orient the apparatus 100 appropriately to determine the location and depth of a hidden object, as discussed in greater detail below. The levelling device 108 may be a liquid level, gyroscope, dumpy level, automatic level, laser level, goniometer, theodolite, or other mechanism usable to determine the orientation of the apparatus 100.

Alternatively or additionally, the apparatus may include position locating and logging capabilities, such as GPS functionality, gyroscopes, accelerometers, a mechanism for detecting local known sources of signals (e.g., Wi-Fi, telecommunications towers, or other signal sources), or mechanisms for alternative location determination. Such position locating features may facilitate the logging of object locations and the determination of object depths based on applications of the Pythagorean Theorem, trigonometry, and other algorithms.

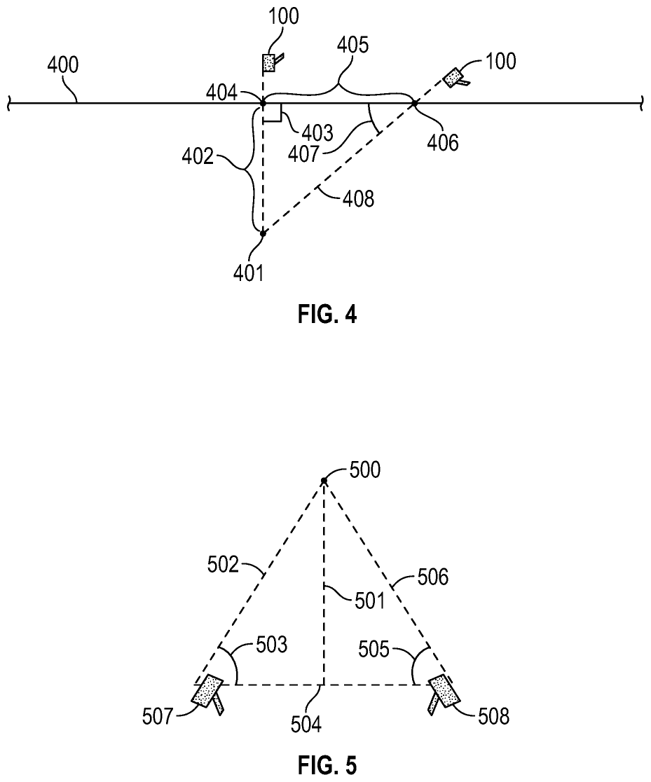

FIG. 4 illustrates a use of an apparatus 100 to ascertain the depth of an object 401 embedded in a material 400. First, the object can be located by using the apparatus 100 to radiate a first transmitted beam onto the material and to receive a first reflected beam 402 from the object that is a reflection of the first transmitted beam. When the object is identified, the user can orient the apparatus (such as by using the levelling device 108) so that the beam is directed perpendicularly into the material above the hidden object. When the object is successfully located, a first location 404 directly above the object can be recorded. Next, the object 401 is located a second time by using the apparatus 100 to radiate a second transmitted beam into the material 400 at a second angle 407 from the surface of the material, and receiving a second reflected beam 408 from the object. To simplify calculations to determine the location of the object, the second angle 407 can be 45 degrees. Again, the levelling device 108 can be used to orient the apparatus 100, and thus the beam, at a 45 degree angle relative to the material 400 surface. Once the object is located this second time, a second location 406 can be recorded. The recorded locations may be based on the location where the transmitted beam enters the material 404 or 406, the location of the apparatus 100, or another related location. Recordation of locations may be by physically marking the material, by positionally marking the location by GPS, accelerometers, gyroscopes, local known sources of signals (e.g., Wi-Fi, telecommunication towers, and other signal sources), or by or in combination with alternative location determination methods.

Based on the first location 404, second location 406, second angle 407, and distance between the first and second locations 405, the depth of the object may be calculated using simple trigonometry, such as, for example, by the Pythagorean Theorem (i.e., a²+b²=c²), or other known methods. As illustrated in FIG. 4, when a first angle of 90 degrees and a second angle of 45 are used, the depth of the object is equal to the distance between the first and second locations 405. However, other angles may be used insofar as sufficient information is provided to determine the depth of the object.

The apparatus may also include features to indicate the path of the antenna's general radiation pattern, and therefore the path of the transmitted beam and reflected beam. This feature may be a laser pointer mounted on the apparatus, or a mark-creating feature such as a paint gun, paintball gun, or other mechanism capable of indicating the location of an object. The apparatus 100 may additionally include an image recording device, such as a video camera, which can aid in the recordation of locations by, for example, recording the precise location identified by the laser pointer or marked by paint. The image recording device may additionally allow a user to visually observe the environs of the apparatus 100, which may be useful if the apparatus 100 is mounted on a vehicle, such as a bulldozer or remote-controlled vehicle. The apparatus 100 may further incorporate a microphone and or speaker to allow recordation or remote observation of sound by a user or the broadcasting sound from the apparatus 100.

FIG. 5 depicts a method of detecting an object 500 using at least two exemplary locating apparatuses 507, 508. Both apparatuses 507, 508 are depicted detecting an object 500, based on the path of a first transmitted beam and its reflection 502 from the first apparatus 507 and a second transmitted beam and its reflection 506 from the second apparatus. Knowing the distance between the two apparatuses 504, the angles of the first and second transmitted beams 502, 503, the distance to the object 501 may be ascertained.

Applying the same principles as the method of detecting an object described in FIG. 5, a location detection apparatus may include multiple transmitting or receiving antennas, coupled with transmitters, receivers, and phase detectors to ascertain the location of an object based on phase differences between transmitted beams and received beams reflected from the object. Insofar as sufficient information is known to perform the calculation, an object's location may be determined through the use of a single locating apparatus. Such information may include the distances between transmission and receiving antennas, the angles between transmitted and received beams, angles of incidence between the beams and material in which an object is embedded, the location of the apparatus used, or the vectors of the transmitted and received beams.

The apparatus may additionally be utilized as a component of heavy construction equipment involved in earthworks, such as bulldozers, graders, loaders, backhoes, excavators, and similar machinery. When mounted on or near the blade of a piece of heavy construction equipment, the apparatus may be used to detect when the equipment is about to make contact with a rock, pipe, cable, or other object that would not be desirable to contact.

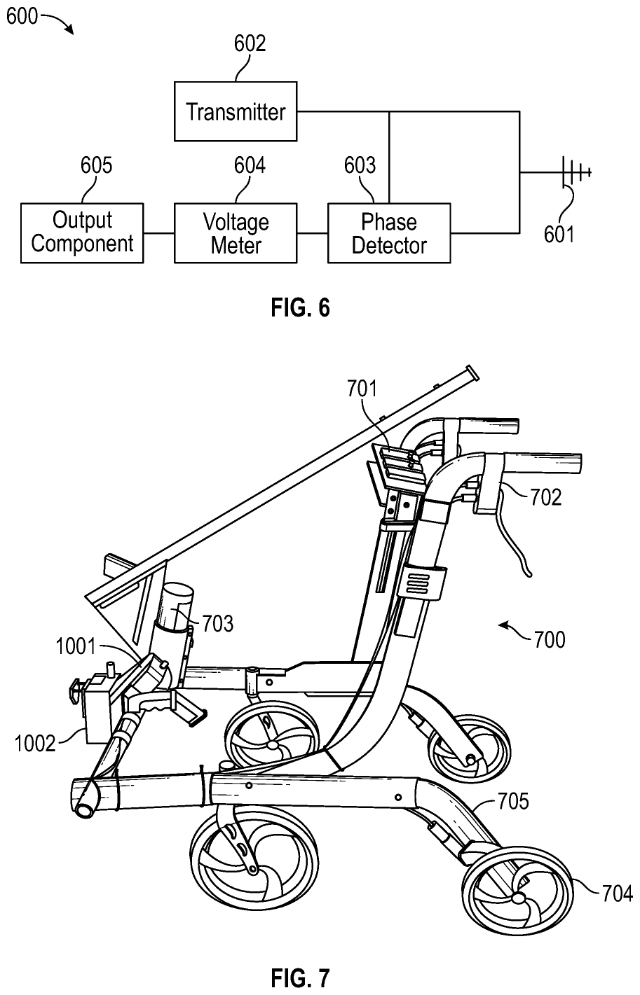

FIG. 6 is a block diagram of an exemplary locating apparatus 600. The apparatus 600 possess an antenna 601 connected to a transmitter 602 and a phase detector 603. The apparatus may optionally include a separate receiver coupled with the antenna 601 that receives the reflected signal, provided that the receiver does not interfere with the phase of the reflected signal received by the phase detector 603. The antenna 601 is configured to transmit a beam of electromagnetic energy based on a transmitter signal from the transmitter 602. The phase detector 603 is configured to receive a reflected signal based on a reflected beam received by the antenna 601, the reflected beam being based on reflections of the transmitted beam. These beams of electromagnetic energy may be in any frequency and amplitude, but beams in the microwave range (10 MHz to 2.6 GHz) are preferable. Higher frequency beams around 2.4 GHz are advantageous because a smaller antenna may be utilized, facilitating hand-held use of the apparatus. Higher frequency beams also exhibit shorter wavelengths, allowing for more precise detection. The transmitter 602 may be an independent component or integrated as a transceiver. The transmitter 602 is coupled with a phase detector 603 which outputs a voltage based on the phase difference between the transmitter signal and the reflected signal. The voltage output by the phase detector 603 is received by a voltage meter 604, which measures the voltage and transmits a voltage reading output to an output component 605. In some embodiments, the output component 605 may be a display displaying a value or indication based on the voltage reading output, a logging device that records the voltage reading output for later processing, or a transmission device that transmits the voltage reading output for recording, processing, or future analysis. When the output component 605 is a logging device or transmission device, it may comprise a processor, memory, and other computer components in addition to location detection components such as GPS radios, accelerometers, gyroscopes, or sensors to ascertain location based on sources of signals.

A notification component may also be incorporated into the apparatus, which issues a notification when the phase detector detects a phase difference sufficient to indicate the presence of an object. The notification may be via visual, such as a light, flag, or number, audible sound, haptic vibration, augmented reality, or another indication mechanism. The threshold for a phase difference may be adjusted or set based on the type of object intended to be detected, such as a metallic or plastic object.

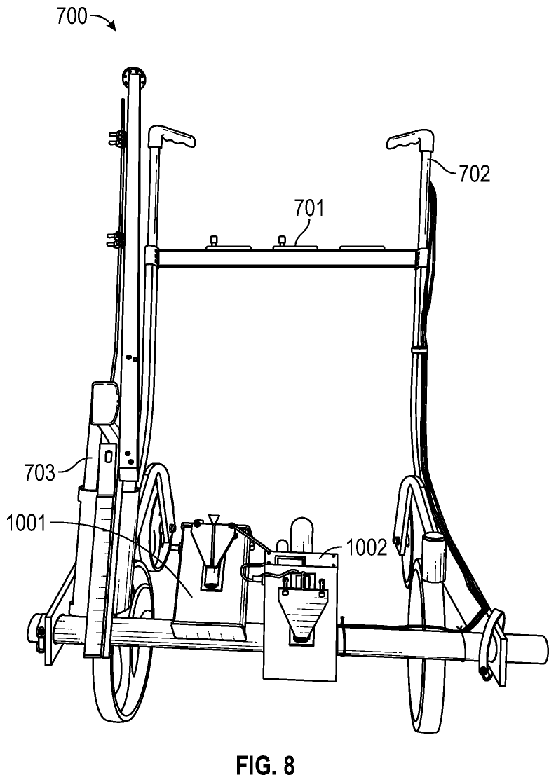

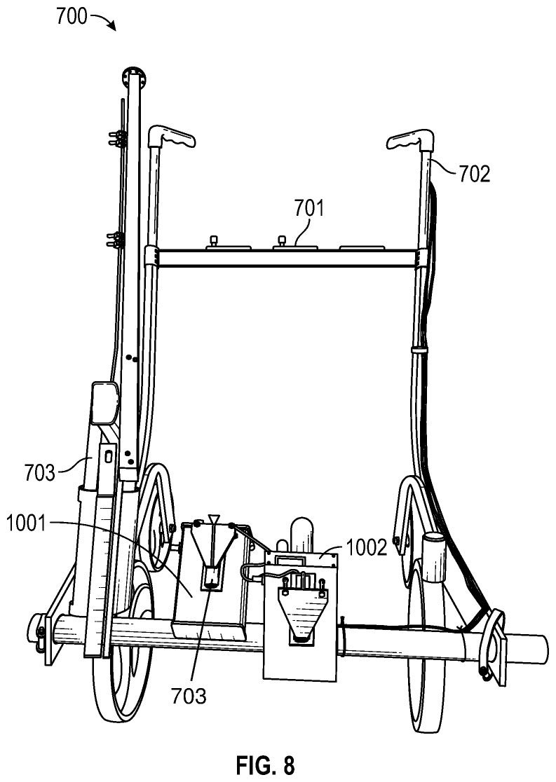

FIG. 7 and FIG. 8 are side and front views, respectively, of a vehicle 700 upon which one or more exemplary locating apparatuses 1001, 1002 can be affixed. The vehicle 700 additionally includes a remote activation device 701 coupled with the at least one locating apparatus 1001, 1002, which allows a user to activate the locating apparatus 1001, 1002. The remote activation device 701 may include buttons, switches, knobs, or other user input mechanism. The remote activation device 701 may also include an output component, such as a display, data logging device, or other output mechanism. The vehicle 700 may include wheels with optional integrated braking mechanism 704, a body frame 705, and handles with integrated braking mechanisms 702 may be present to enable a user to maneuver the vehicle 700.

The vehicle 700 may also include a marking mechanism 703, such as a laser pointer or a mark-creating feature such as an aerosol paint can, a paint gun, paintball gun, or other method of creating a mark to indicating the location of an object. Alternatively, the marking mechanism 703 may incorporate location detection components such as GPS radios, accelerometers, gyroscopes, or sensors to ascertain location based on sources of signals and a recording apparatus to record the location. When two locating apparatuses 1001, 1002 are affixed to the cart apparatus 700 at different angles, the cart apparatus may be utilized to determine the location and depth of an object. For example, upon detecting the object with the first locating apparatus 1001 affixed to the vehicle 700 at a first angle, a user may record the location of the apparatus with the marking mechanism 703, such as by marking a first location. Next, the vehicle 700 may be maneuvered until the object is detected with the second locating apparatus 1002, affixed to the vehicle 700 at a second angle. And when the object is detected with the second locating apparatus, the location of the apparatus 1001 may be recorded or the marking mechanism 703 may be used to mark a second location. Knowing the angles of the locating apparatuses 1001, 1002, and the distance between the first and second locations, the precise depth and location of the object may be ascertained through trigonometry, the Pythagorean Theorem, or other algorithms, as discussed in greater detail above.

The depiction of multiple apparatuses attached to a cart, as shown in FIG. 7, is exemplary of the concept that the apparatuses can be attached to any appropriate vehicle or movable device, depending on the particular nature of an object to be identified. For example, where the apparatuses of the present technology are used to identify pipelines in the field, the apparatuses can be attached to a truck or other utility vehicle, which can be maneuvered as locations of buried objects are identified and marked.

The foregoing aspects, features, and advantages of the present technology will be further appreciated when considered in reference to the following description of certain embodiments and accompanying drawings. In describing the embodiments of the technology illustrated in the drawings, specific terminology will be used for the sake of clarity. The invention, however is not intended to be limited to specific terms used, and is understood that each specific term includes equivalents that operate in a similar manner to accomplish a similar purpose.

I claim:

1. An apparatus for detecting an object, comprising:
a transmitter;
an antenna that receives a signal from the transmitter, radiates a transmitted beam of electromagnetic energy, and receives a reflected beam of electromagnetic energy, the reflected beam being a reflection of the transmitted beam when the transmitted beam is reflected from an object;
a phase detector in communication with the antenna that detects a phase difference between the transmitted beam and the reflected beam, and that produces a voltage output proportional to based on the phase difference; and
a voltage meter that receives the output and produces a voltage reading.

2. The apparatus of claim 1, wherein the antenna is a log periodic antenna.

3. The apparatus of claim 1, further comprising a laser aligned approximately in the direction between the antenna and the object.

4. The apparatus of claim 1, further comprising a levelling device attached or integral to the apparatus to detect the orientation of the apparatus.

5. The apparatus of claim 1, further comprising an oscilloscope in communication with the voltage meter that displays an output based on the voltage reading.

6. The apparatus of claim 1, further comprising a potentiometer in communication with the phase detector and the voltage meter to adjust the output.

7. The apparatus of claim 1, further comprising frequency modulator in communication with the antenna.

8. The apparatus of claim 1, further comprising a handle to enable hand-held operation by a user.

9. The apparatus of claim 1, wherein the frequency of the transmitted beam is about 2.4 GHz.

10. (canceled)

11. The apparatus of claim 1, further comprising an output component that receives the voltage reading from the voltage meter.

12. The apparatus of claim 1, further comprising a display that produces a second voltage output based on the voltage reading.

13. The apparatus of claim 1, further comprising a location detection component.

14. A method of detecting an object, the method comprising:
a) transmitting a transmitted beam of electromagnetic energy from an antenna at an object;
b) receiving a reflected beam of electromagnetic energy with the antenna, the reflected beam being a reflection of the transmitted beam when the transmitted beam is reflected from the object, the reflected beam having a different phase from the transmitted beam based on the distance between the apparatus and the object;
c) producing with a phase detector a voltage output proportional to the phase difference;
d) receiving with a voltage meter the voltage output; and
e) producing with the voltage meter a corresponding voltage reading.

15. The method of claim 14, further comprising displaying on a display an output based on the voltage reading.

16. The method of claim 14, wherein steps a) and b) include transmitting and receiving the respective beams of electromagnetic energy with an antenna.

17. The method of claim 14, further comprising:
f) performing steps a) and b) a first time with the transmitted beam of electromagnetic energy directed substantially vertically downward toward the object;
g) recording a first location based on the location of the source of the transmitted beam during performance of step f);
h) performing steps a) and b) a second time with the transmitted beam of electromagnetic energy directed at an angle toward the object;
i) recording a second location based on the location of the source of the transmitted beam during performance of step h);
j) determining the depth of the object based on the first location, the second location, and the angle of the transmitted beam at the second location.

18. The method of claim 17, wherein step f) is performed by a first apparatus attached to a vehicle, and step h) is performed by a second apparatus attached to the vehicle.

19. A vehicle for detecting a buried object, comprising:
a first apparatus for detecting the buried object, the first apparatus comprising:
a first transmitter;
a first antenna that receives a signal from the first transmitter, radiates a first transmitted beam of electromagnetic energy substantially vertically toward the buried object, and receives a first reflected beam of electromagnetic energy, the first reflected beam being a reflection of the first transmitted beam when the first transmitted beam is reflected from an object; and
a first phase detector in communication with the first antenna that detects a first phase difference between the first transmitted beam and the first reflected beam, and that produces a first voltage output proportional to based on the first phase difference;
a first marker to identify the position of the first apparatus when the object is identified;
a second apparatus for detecting the buried object, the second apparatus comprising:
a second transmitter;
a second antenna that receives a signal from the second transmitter, radiates a second transmitted beam of electromagnetic energy at an angle toward the buried object, and receives a second reflected beam of electromagnetic energy, the second reflected beam being a reflection of the second transmitted beam when the second transmitted beam is reflected from an object; and
a second phase detector in communication with the second antenna that detects a second phase difference between the second transmitted beam and the second reflected beam, and that produces a second voltage output proportional to the second phase difference; and
a second marker to identify the position of the second apparatus when the object is identified.

20. The vehicle for detecting a buried object of claim 19, further comprising a first voltage meter that receives the first voltage output and produces a first voltage reading, and a second voltage meter that receives the second voltage output and produces a second voltage reading.

21. The method of claim 14, further comprising issuing a notification when the output from the phase detector changes by more than a preset threshold amount to indicate the detection of an object.
